(19) United States
(12) Patent Application Publication
(10) Pub. No.: US 2014/0130648 A1
(43) Pub. Date: May 15, 2014

(54) BOOK TRIMMING APPARATUS

(71) Applicants: John Cracknell, Berkshire (GB); Mark Firth, Buckinghamshire (GB); John O'Brien, Buckinghamshire (GB); Martin Brewster, Buckinghamshire (GB)

(72) Inventors: John Cracknell, Berkshire (GB); Mark Firth, Buckinghamshire (GB); John O'Brien, Buckinghamshire (GB); Martin Brewster, Buckinghamshire (GB)

(73) Assignee: IBIS INTEGRATED BINDERY SYSTEMS LTD, Buckinghamshire (GB)

(21) Appl. No.: 14/158,502

(22) Filed: Jan. 17, 2014

Related U.S. Application Data
(63) Continuation of application No. 12/090,532, filed on Aug. 26, 2008.

(30) Foreign Application Priority Data
Oct. 17, 2005 (GB) 0521020.8

(51) Int. Cl. B26D 7/08

(52) U.S. Cl. CPC B26D 7/08
USPC 83/19

(57) ABSTRACT

The book trimming apparatus includes guides which direct a collated and, optionally, bound book to a fore-edge trimming station. The book trimming apparatus further includes a transfer station and a side-edge trimming station. For both the fore-edge trimming station and the side-edge trimming station in each case the book is orientated so that the edge to be trimmed is arranged substantially parallel to the direction of motion of the book. The automated book trimming apparatus is particularly suited for use in combination with collation and binding stations in in-line book manufacture.

### TECHNICAL FIELD

This invention relates to the field of printing, in particular to a trimming apparatus capable of creating accurately-sized books of pre-determined dimensions from stacks of collated sheets.

### BACKGROUND ART

In conventional, commercial book-making apparatus, pre-printed sheets are generally collated, bound and then trimmed either to form a book directly or a part thereof. The present invention relates to apparatus for carrying out the trimming process and, as such, is suitable for use with most of the various known apparatus that carry out collation or binding in accordance with the prior art. Accordingly the invention will be described in relation to a stack of collated sheets, regardless of how the stack is formed and however it is (or is not) bound. Within the industry, a stack of such sheets may variously be referred to as a book, book-set, booklet or brochure. It shall be referred to herein as a “book”, which term is to be understood as encompassing alternative terminologies, as appropriate.

In the conventional apparatus, the book is delivered to the trimming apparatus downstream of any binding or stitching process. Typically the book will be delivered to the trimmer spine first, on either a flat or an inclined bed. The trimming operation, which aims to provide accurately-sized products finished to a commercial standard, is generally carried out in two stages. First, a reciprocating knife set trims the edge opposite the spine (the “fore edge”) to fix the book's width. The book is then transported to a second station at which the edges parallel with the direction of transport (“side edges”) are trimmed using knives mounted on a reciprocating apparatus. Additional knives may also be mounted on this apparatus (‘centre knives’) for use when multiple side-by-side imprints have been made to create multiple books simultaneously. Multiple imprints permit more efficient use of paper and upstream printing apparatus. The centre knives are then used to divide the book into the appropriate number of separate, small books at this final stage of processing. Finished single books of correct size are then typically output to a delivery conveyor.

The multiple mechanical handling operations and the large forces involved in book trimming operations have tended to dictate the design of automated trimming apparatus. A typical example of prior art trimming apparatus is shown in FIG. 1. It can be seen that this apparatus is surprisingly bulky and complex. A book must first be moved, spine leading, to the fore-edge trimming station and then stopped to very close tolerance before it is cut. Accurate alignment is needed to ensure a correct finished book width and parallel spine and fore edge. The book is then accelerated to a second station where it must again be stopped and aligned to ensure accurate side-to-side registration before side-edge and centre trimming. Accelerating the book and then stopping it quickly and accurately are procedures that present considerable technical challenges to automated book trimming. Problems may include the book ‘bouncing’ against registration stops as a result of residual momentum; marks on or damage to the book as transport mechanisms act to accelerate or decelerate it rapidly; and damage to the spine or edges as a result of impact against registration stops.

### DISCLOSURE OF INVENTION

In response to increasing competition within their industry, producers of books and other printed materials are not only demanding increased throughput and book quality from their bookbinding process, but are also in need of more space-, capex- (capital expenditure/purchase cost) and skilled-labour saving options.

It is an object of the present invention to provide an alternative trimming apparatus and method for use within the bookbinding process, which is capable of meeting at least some of the above-listed requirements for improved performance.

Accordingly the present invention provides book trimming apparatus comprising a fore-edge trimming station, side-edge trimming station and a transport system for transporting a stack of collated sheets, comprising all or part of a book having a spine, in a transport direction therethrough. The fore-edge trimming station is arranged to trim the stack along an edge opposite to the spine and the side-edge trimming station arranged to trim the stack along edges perpendicular to the spine. The invention is characterised in that the fore-edge trimming station, side-edge trimming station and transport system are so arranged such that, in both the fore-edge trimming and side-edge trimming stations, the edge of the stack that is to be trimmed is, at the time of trimming, oriented substantially parallel to the transport direction from which it approaches its trimming position.

This arrangement provides the opportunity for book binding using cheaper, smaller and lighter apparatus than is known in the prior art, without compromise to quality and throughput.

Conventionally, a book is transported through trimming apparatus spine-first on a flat surface. Accordingly, it follows that the fore-edge of the book is trimmed across the transport direction.

In the present invention, the cutting direction is set to be parallel with the delivery transport direction at each trimming procedure and consequently the strict tolerances on stopping the book are somewhat relaxed. The book is still halted or slowed for cutting, but residual movement in the transport direction will not result in an uneven or misaligned cut. This is to be contrasted with conventional book-trimming designs in which the fore-edge is cut across the transport direction. Any movement in the transport direction from the book's intended stop position will cause the fore-edge cut to be in the wrong place. Similarly, if the book is not stopped square, the fore-edge will not be cut parallel with the spine. If it bounces off the registration stops, the book will not be cut to the exact width. Acceleration requirements are also relaxed by this invention: if the book is permitted some residual momentum as it is cut, then it need not be accelerated from a completely stationary position. This further permits a smaller and lighter design of apparatus.

U.S. Pat. No. 6,805,340 describes alternative apparatus for producing bound printed products in which the side-edges are cut across the line of transport. In this apparatus the book is transported vertically, which permits, as in the present invention, the fore-edge to be cut in the direction of transport. However, despite imparting a rotation to the transport direction in order to make the apparatus more compact, the side-edges are still trimmed in the vertical direction. That is, across the line of transport. The substantial benefits to be had in avoiding all trimming across the transport direction have clearly not heretofore been appreciated.

The present invention is applicable to stacks of sheets formed by any collation or binding process. It is though most suitable for implementation with processes in which the stack is collated on a saddle and then bound by either saddle-stitching or saddle-gluing. Alternatively however, the stack may be collated and bound by a perfect-binding process. This latter technique is generally used to produce paperback books. A further alternative, which is used to form newspapers and the like, is to collate folded sheets on a saddle and to leave them unbound.

The transport system is preferably arranged such that the transport direction is turned through approximately 90° between the fore-edge trimming and side-edge trimming stations. This ensures that the relevant edges are parallel to the transport direction as they are cut at respective stations. This turn may be effected outside the two stations, remote from the first cutting position, or at the first station, immediately after the first trimming operation.

While it is very much preferred that the transport direction is linear through the trimming stations (or at least at the instant of cutting), it is also possible that the transport direction may describe a circular path through and between trimming stations. In this case the book's edges will, strictly, be tangential to the transport direction as they are cut.

This invention is specifically intended to be most suitable for operation with saddle-bound books and so it follows that the most straightforward implementation is to maintain the book's orientation on the saddle (or alternative support such as a book support plate) as the first trimming operation is carried out. Accordingly, the fore-edge trim is preferably made immediately after sheet collation and, if the sheets are bound, either at the binding station or at an immediately successive station. Sheets are collated on the saddle to form a partly open stack, which has leaves depending to either side of the saddle support. These leaves are then pushed closed to a vertical position in preparation for fore-edge trimming. Trimming is therefore effected with the sheets in a vertical arrangement, with minimal movement from their collation orientation, without cutting across the transport direction. The transport direction is then changed and the side-edge trim preferably made at a downstream station.

In order to provide for a change of transport direction, the transport system may further comprise guide rails oriented at approximately 90° to transport belts. The guide rails of this embodiment are arranged to support the stack as it exits the fore-edge trimming station (when the transport direction is substantially parallel to the guide rails) and the transport belts are arranged to carry the stack through the side-edge trimming station (when the transport direction is substantially parallel to the transport belts). The transport system may then be arranged such that the stack is oriented on the guide rails with its spine towards the transport belts and further arranged such that the stack remains in this orientation on its transfer to the transport belts such that it is transported spine-first through the side-edge trimming station.

In the prior art, it has traditionally proved difficult to design a single transport system that retains custody of the book throughout the trimming process because the fore-edge knives need to shear across the line of transport. These knives must inevitably also cut across any belts or guides that are supporting the book. Accordingly, the book must either be released from such supports when at least one of its edges is trimmed or a complex holding arrangement is required. Usually, the latter approach is adopted. For example, belts travelling at similar speeds are located to either side of the cutting plane, with the gap between successive drive mechanisms being less than a single book-width. The additional complexity contributed by the need for multiple belts or drive wheels is avoided by the present invention. The potential for using a simplified design of apparatus is therefore a second advantage of this invention: by making cuts parallel with the transport direction, transport belts may retain custody of the book through more of the process while still permitting the number of releases to be minimised. This reduces the possibility of losing sheet registration and consequent misalignment of the book's pages.

By separating cutting operations, as inevitably follows from the change of transport direction, the present invention offers a further advantage over the conventional set-up used in the prior art. Conventionally, the fore-edge trimming and side-edge trimming operations are in-line. This enables a single drive mechanism to be used to raise and lower together the side-edge knives that trim one book and the fore-edge knife that trims the book immediately following. This arrangement means that, in order to process different book formats using the same equipment, it is the fore-edge position of the book that sets the position for trimming both the fore- and side-edges. That is, it is not usually possible to pre-determine the exact stopping point of the spine as the side-edge trim is made. This potential problem is overcome in the prior art by the use of relatively long cutting knives and clamping surfaces, rendering the exact stopping position immaterial. By way of contrast, in the present invention it is the position of the spine that sets the position at which the side-edges are cut. This potentially permits use of a bespoke clamp and knife assembly to effect trimming of the book, which further improves the likelihood of maintaining sheet registration. In prior art systems, the inability to control the spine position across a range of book formats means that a universal clamping system is typically used; that is, one designed to clamp at the flat portion of the book. The spine however, being relatively unsupported, is the most readily deformable part of the book and consequently the most severely damaged during cutting. “Nicking” and tearing of the spine is particularly common on thicker books. The possibility of using a clamping system that is specifically designed to support the spine as the book is cut offers a further advantage of this invention. In another aspect therefore, which will be described in more detail below, this invention provides a novel design of spine clamp.

The transport belts may have associated gripping means and the gripping means may be arranged to grip the spine of the stack as it reaches the transport belts and thereby transfer the stack, spine first, to the transport belts. Alternatively, the transport system may also include at least one push-up finger arranged to raise the spine of the stack as it reaches the transport belts and to urge the stack onwards in this orientation. Both these embodiments provide examples of the stack being manipulated at or close to its spine.

The guide rails are preferably arranged to support the stack inclined at an angle to the vertical when it reaches the gripping means or push-up finger such that its spine is tilted towards the side-edge trimming station. The transport direction through the side-edge trimming station may further be inclined upwards at an equivalent angle. This angle is preferably between 30° and 60° and, more preferably, around 45°. This arrangement permits the final delivery height to be selected by adjusting the set up of the apparatus. Ideally, the finished book is delivered to a conveyor at a height that is most suitable for retrieval by a human operator.

Alternatively, the guide rails may keep the stack in its vertical orientation. The stack is then lifted upwards to a desired height before being rotated about its spine to a flat position, in which it is transported through the side-edge trimming station.

The side-edge trimming station may further comprise at least three co-planar knife assemblies, two of which are positioned to trim respective side edges of the stack and at least one of which is arranged to cut across the stack along an inner line in a direction parallel to the side edges. This renders the trimming apparatus more flexible: it can now be additionally used to process the final stage of book creation if multiple side-by-side imprints of a book have been made on the same sheet. Generally the inner knife assembly comprises a pair of knives, separated by a short distance. The portion of sheets intermediate the two knives, cut from the original stack, is discarded as it is usually deformed by the rounded non-cutting surface of each knife. Such an arrangement is well known in the prior art: this third (or subsequent) pair of knives is used to divide the stack to create the appropriate number of separate, small books. The flat surface of each knife effects a clean cut along the edge of the finished product.

In a second aspect, the present invention provides a method of trimming a stack of collated sheets, the sheets comprising all or part of a book having a spine, as they are moved in a transport direction, the method comprising the steps of:
1. Transporting the stack to a fore-edge trimming orientation in a fore-edge trimming station and trimming the stack along an edge opposite to the spine, the fore-edge trimming orientation being such that the edge to be trimmed is oriented substantially parallel to the transport direction from which it approaches its trimming position;
2. Changing the relative orientation of the stack and the transport direction such that edges perpendicular to the spine are parallel to the transport direction; and
3. Transporting the stack in this orientation through a side-edge trimming station and trimming the edges perpendicular to the spine.

In a third aspect the present invention provides book trimming apparatus comprising a transport system for transporting a stack of collated sheets folded at a spine in a transport direction to a fore-edge trimming station containing a knife assembly arranged to trim the stack along an edge opposite to the spine wherein the stack is oriented such that its spine is parallel to the transport direction and the knife assembly is arranged such that, when operated, the stack is cut along its fore-edge in a direction substantially parallel to the transport direction characterised in that the fore-edge trimming station includes a book support plate arranged to support the stack internally at its fold line and from which the stack hangs substantially vertically as it is transported through the station.

This aspect of the invention may be implemented with saddle-collated bound or unbound books. When the book is suspended from the book support plate, its two leaves will tend to separate as a result of the finite size of the plate at its spine. Accordingly the apparatus should further include a clamp for clamping the sheets together at a point at or near their fore-edge. In this way the book will be pressed flat from the sides and held firmly in its closed position.

The prior art apparatus described in U.S. Pat. No. 6,805,340, referenced above, is arranged to cut the fore-edge as the book is held vertically. However, the book is not suspended from a book support plate as it is cut but is merely held in position by transport belts. Belts are not capable of positioning the book sufficiently accurately for trimming. Accordingly, this prior art fore-edge trimmer will tend to produce books that are finished to a somewhat lower quality than those produced using the apparatus of the present invention.

The fore-edge trimming station of this aspect of present invention may be used either alone or as a component station of the book trimming apparatus described previously.

In a preferred embodiment of this invention, the book support plate is sprung in the vertical plane and the fore-edge trimming station also includes a spine depressor arranged to urge the spine of the stack downwards as the stack is supported by the book support plate during fore-edge cutting. The action of the depressor further assists in accurately positioning the stack for trimming. Moreover, the depressor is particularly advantageous if applied to stacks of sheets that are bound by gluing. In this embodiment, glue is applied to the sheets at their fold line as they are collated on the saddle. Depressing the folded sheets downwards will first assist in maintaining alignment of the sheets as the glue dries; will secondly encourage setting of the glue and will thirdly hold the position of the stack with sufficient accuracy for cutting.

In this aspect of the invention, the book is suspended from the inside of its spine, whereas the width of the finished book must be set from the outside of the spine. If books of identical thickness and of a particular width are being processed then the knife assembly may be set to be an appropriate distance below the support plate or depressor. However, if books of different thicknesses are to be processed in the same operation, merely setting this distance is not sufficient. Accordingly, it is preferred that the spine depressor has a fixed limit position to its downward movement towards the book support plate and is arranged to be at this position when the stack is cut. For a thick book, the spine may be some 5 mm thick. The present embodiment enables the outside of the spine to be pressed to a pre-determined position, regardless of the thickness of the spine (within reasonably expected limits). The knife assembly need not therefore be moved as different book thicknesses are processed, as long as the finished format (e.g. A4) stays constant.

Clearly, in order to process books of different formats and different thicknesses, the knife-assembly should include adjustment means for setting the distance from the spine-depressor's limit position at which the stack is cut.

The knife assembly and clamp may be part of an integral unit, which preferably includes a knife bed plate and reciprocating knife. With this arrangement the cutting forces may be contained within the integral cutting unit.

A reciprocating knife is one that operates in a shearing action against the bed plate, which generally contains a slot to permit the knife to pass. A reciprocating knife is most commonly used for trimming in the bookbinding industry, although alternatives, such as a rotating cutter are possible. Accordingly, this invention may also include alternative cutting implementations.

In a fourth aspect the present invention provides a method of trimming a stack of collated sheets folded at a spine at an edge opposite to the spine, the method comprising the steps of:
1. Supporting the stack internally at its fold line such that it hangs downwards, suspended at the spine;
2. Transporting the stack to a cutting position in a direction longitudinal to its spine; and
3. Cutting the edge opposite the spine in a direction substantially parallel to the spine.

In a fifth aspect the present invention provides book trimming apparatus comprising a transport system for transporting a stack of collated sheets folded at a spine through a side-edge trimming station, the stack being oriented such that it is transported spine-first, wherein the side-edge trimming station contains a knife assembly arranged to trim the stack along edges perpendicular to the spine and a clamping system for holding the stack during cutting, characterised in that the clamping system comprises a spine clamp with profiled spine-engaging surface, the surface being shaped such that, when the clamp is moved towards the stack, the spine is engaged first at its apex, which is moved towards a knife bed plate, and then engaged progressively across the stack as it thickens, thereby deforming the spine such that it is compressed onto the bed plate.

Compressing the spine against the bed plate in this way provides positive support to the sheets in the stack during the cutting process. In conventional designs of side-edge trimmers the book generally lies flat on the bed plate at the moment it is cut and clamps are used to prevent lateral movement. However, the finite thickness of the book raises the spine half a book thickness above the bed plate. The edges of the book close to the spine are therefore not held by the clamping mechanism. There is insufficient strength in the paper alone to hold in position the sheets at the spinal region that are remote from the clamp. The paper at these edges therefore tends to move as the sides are cut. As a result, the sheets are liable to be torn or “nicked” in the region of the spine, leading to an untidy finished product. This has obvious quality implications, particularly if the book is to be sold.

The side-edge trimming station described in relation to this aspect of the invention may be used either alone or as a component station of the book trimming apparatus described previously. In either case, the position of side-edge trimming must be set by the spine position. That it, the book must be stopped accurately with its spine at a predetermined location in order to permit the spine clamp to engage the spine correctly, regardless of the format of the book. This requires the fore- and side-edge trimming operations to be separated, which is not generally the case in conventional machines For this reason, the present design of side-edge trimming station is most advantageously used as a component of the book trimming apparatus according to the first aspect of this invention.

The clamping system should preferably also comprise a book clamp for pressing the bulk of the stack against the bed plate once the spine clamp is in its clamped position.

The knife assembly preferably comprises an upper knife along with the knife bed plate. Furthermore, the knife assembly and clamping system are preferably part of an integral unit. The upper knife may be of conventional straight design, or it may have a profiled cutting edge. It has been found that appropriate clamp design is by far the most important factor in achieving a clean cut in the spinal region. A further small improvement may however be gained by use of a profiled cutting blade. Ideally, the profiled cutting edge of the knife is similar to the profile of an upper surface of the book close to the spine, when clamped, such that when the knife is moved towards the clamped stack, the spine is cut first at its apex and then progressively across the stack as it thickens. To achieve the progressive cut, the knife may be angled or its profile exaggerated in comparison with that of the clamped book. Alternatively, the upper knife cutting edge is substantially similar to the profiled surface of the spine clamp.

The knife assembly may further be arranged to cut the stack along at least one inner line in a direction perpendicular to the spine and the clamping system is then arranged to hold the stack in the vicinity of this inner line or lines during cutting.

In a sixth aspect the present invention provides a method of trimming a stack of collated sheets folded at a spine along at least one edge perpendicular to the spine, the method comprising the steps of:
1. Providing a spine clamp with profiled spine-engaging surface above the stack in the vicinity of the edge to be trimmed;
2. Moving the clamp towards the stack wherein the profile of the clamp is such that the spine of the stack is engaged first at its apex, which is displaced towards a knife bed plate;
3. Continuing depressing the clamp such that the stack is engaged progressively as it thickens, thereby deforming the spine, until the deformed spine is compressed onto the bed plate; and
4. Trimming the edge of the clamped stack.

The method may also include providing two spine clamps for clamping opposite side-edges of the stack, and trimming both side-edges. It may further include providing at least one additional spine clamp for clamping the stack along at least one inner line in a direction perpendicular to the spine and cutting the stack in the vicinity of this inner line. As described previously, a pair of knives is generally used in the art to divide the stack once along a pair of closely-spaced parallel lines. Two pairs of knives are used to divide the stack twice, etc. Accordingly, this method will generally involve providing two inner spine clamps per inner knife pair.

### BRIEF DESCRIPTION OF THE DRAWINGS

Embodiments of the invention will now be described by way of example only and with reference to the following drawings.

FIG. 1, as previously described, is a diagram of prior art book trimming apparatus.

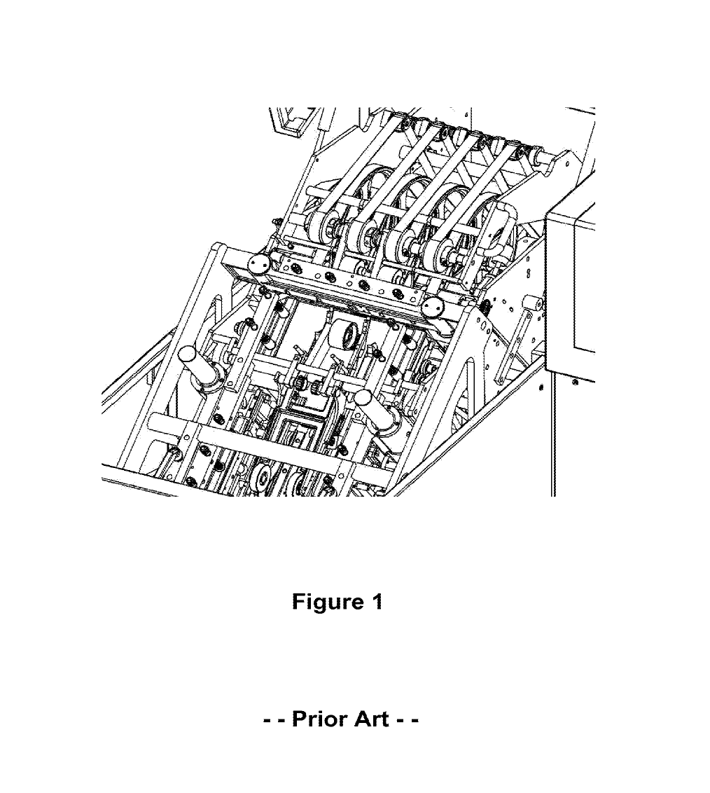

FIG. 2 is a plan view that illustrates schematically apparatus in accordance with this invention that is used at various stages in the book binding process.

FIG. 3 is a schematic illustration of a fore-edge trimming station, as shown in FIG. 2, in accordance with the invention.

FIG. 4 is a schematic illustration of a transfer station, side-edge and centre trimming station and delivery belt, as shown in FIG. 2, in accordance with the invention.

FIG. 5 is a diagram showing a perspective view of the side-knife clamping and trimming assembly.

FIG. 6 is an elevational view of the assembly shown in FIG. 5.

FIG. 7 is a diagram showing further detail of a spine clamp component of the assembly of FIGS. 5 and 6.

FIG. 8 illustrates the spine clamp of FIG. 7 when holding a stack of sheets.

FIG. 9 illustrates a knife profile suitable for use with the spine clamping apparatus of FIGS. 7 and 8.

### MODE FOR THE INVENTION

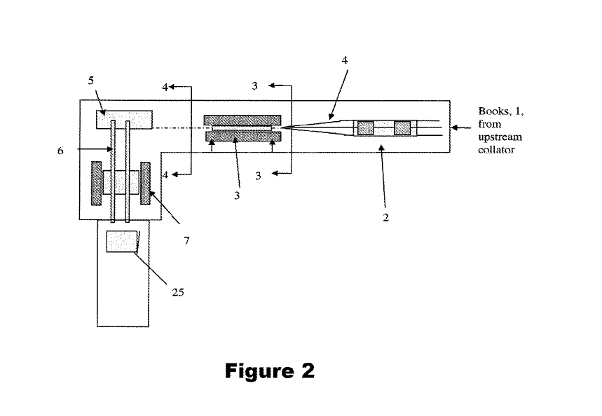

With reference to FIG. 2 there is shown a plan view of a possible layout of bookbinding apparatus in accordance with this invention. Books 1 are delivered from an upstream collating station to a binding station 2. Each book 1 comprises a stack of multiple paper sheets, which are either stitched or glued at the binding station 2. In some instances, for example in the assembly of newspapers, books may be collated on a saddle and left unbound. In these situations, the binding station 2 may be by-passed.

In the embodiment shown the book 1 is collated on a saddle. It remains on this saddle and/or a blade extension thereof, through binding, if required, and afterwards when guides 4 are arranged to manoeuvre the book 1 into a closed configuration whilst transporting it to a fore-edge trimming station 3. As it approaches the fore-edge trimming station 3 the book 1 is travelling in the direction of its spine i.e. longitudinal to its length. At the fore-edge trimming station the book 1 is supported at its spine by the blade extension of the saddle and so hangs vertically. Side pressers and/or clamps ensure that it is in a closed position.

At the fore-edge trimming station 3 a knife assembly is arranged to trim the fore-edge of each book. The position of the knife assembly is adjustable in accordance with the desired width of finished book, in accordance with its format (e.g. A4). The design and action of the knife assembly will be described in more detail below. For the moment it should be noted that, in contrast to traditional trimmer designs, the book 1 is travelling in the direction of its spine prior to cutting. The book 1 is transported in such a way that the edge to be trimmed moves in the same plane as the knives. Accordingly, the exact longitudinal position of the book at the moment of trimming is not critical. Consequently, there is no longer a need to decelerate the book rapidly and to align the spine against registration stops prior to cutting. In this embodiment, the book 1 is brought to rest for cutting, although this is not essential and, as will be evident from the foregoing, cutting can be carried out on a moving book. By way of contrast, in prior art fore-edge trimmers, the knives act across the line of travel and it is therefore essential that the transverse position of the fore-edge is registered accurately prior to cutting if the quality of the finished product is not to be compromised.

After fore-edge trimming the book 1 is conveyed in the direction of its spine length to a transfer station 5. During transport, the book is guided into an angled position (described in more detail below), preferably of between 30 and 60° to the vertical. Belts 6 pick up the book at the transfer station 5 and convey it spine-first to a side-edge/centre-knife trimming station 7. A second knife assembly, which will also be described in more detail below, then trims the book 1 along its side edges and, if required, cuts multiple imprints into separate books.

By changing the orientation in which the book is transported between fore- and side-edge trimming operations, cuts across the line of transport are avoided. In most prior art systems, the fore-edge knives need to shear across the line of transport, making it difficult to design a single transport system that retains custody of the book throughout. The more a book is stopped and transferred between holding belts the more likely the sheets are to lose registration, leading to untidiness in the finished article. For this reason, the belts 6 from the transfer station 5 are arranged to “keep hold” of the book throughout the remainder of the trimming process.

Finished books are then conveyed by belts or other means to a final delivery conveyor 25.

In an alternative embodiment of the invention (not illustrated) books 1 are delivered to a combined binding and fore-edge trimming station. This embodiment is particularly suitable for adhesive binding, for example binding by the process described in international patent application publication no. WO 2005/0729. Glue is applied to the individual folded sheets as they are collated. Collated books, with glue applied, are guided into a vertical position before entering the combined station. The combined station comprises a saddle on which the sheets are mounted in a conventional vertical orientation and then compressed at their spine as the glue is set. The saddle also performs the function of the supporting blade of the fore-edge trimming station, which permits binding and trimming to be executed either concurrently or in immediately successive steps, at a single station.

In a second alternative embodiment (also not illustrated) the stack of sheets 1 is collated and bound by a perfect-binding process, such as typically used to produce paperback books. In this embodiment, the book is mounted on the blade after binding and at some point before the fore-edge trimming operation.

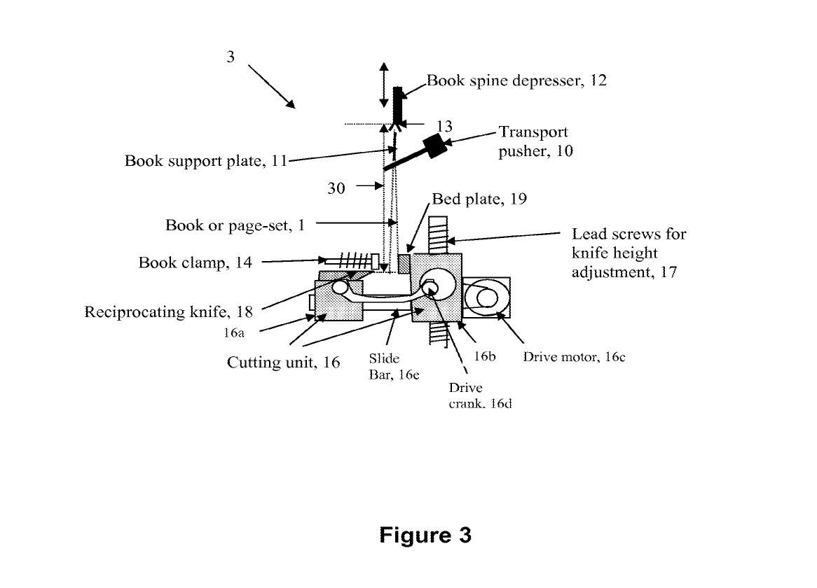

An embodiment of the fore-edge trimming assembly 3 is illustrated in more detail in FIG. 3. A transport mechanism 10, which at this stage of the process is typically a pusher finger, delivers the book from the upstream collating station (or binding station, if included) and stops it at the trimming station 3. Regardless of the binding process, the book at this point hangs from a blade or book support plate 11. In the embodiment shown the book support plate 11 is mounted on sprung supports (not shown) such that it depresses under pressure from a spine depressor 12, which reciprocates in the vertical plane. Clamps 14 are used to close fully and flatten the book 1.

A cutting unit 16 is located a pre-determined distance below the underside of the spine depressor 12 so as to engage the fore edge of the clamped book 1 when in this vertical, flattened position. The cutting unit 16 comprises first 16a and second 16b mounting blocks, supporting a reciprocating knife 18 and knife bed plate 19 respectively. The blocks 16a, 16b are driven towards and/or away from each other by means of a drive motor 16c and rotating crank mechanism 16d, 16e. The unit 16 is mounted on lead screws 17, which are adjustable to set the height of the cutting unit 16 in accordance with the required width 30 of finished product. Cutting is effected between the reciprocating knife 18 and the bed plate 19 as the mounting blocks 16a, 16b are driven together. In this embodiment, the cutting unit 16 is self-contained such that the cutting forces are contained within it.

The height of the cutting unit 16 is adjustable by means of the lead screws 17 in order to permit the apparatus to process books of different widths. To facilitate the processing of books of different thicknesses however, a fixed limit is put on the lowest extent of the spine depressor's vertical travel. The spine depressor 12 is then set to be positioned at this limit when the fore-edge is cut. That is, the width of the book is set from the lowest reach of the spine depressor 12, or equivalently the outside of the spine, to the position of the cutting unit 16. The book support plate 11 is sprung such that it will be pushed further downwards when holding thicker books (i.e. those with more sheets), thus permitting the width of the book to be set, as required, from the outside of the spine. In the absence of the spine depressor 12, the width of the book would be determined by the level of the book support plate 11. That is, from the inside of the spine. If there are many sheets in the book then the spine itself may be up to 5 mm thick. This would accordingly lead to unacceptable variation in book width if books of different thicknesses are processed without adjustment of the relative positions of the support plate 11 and cutting unit 16. Inclusion of the spine depressor 12, as described herein, therefore permits books of differing thicknesses to be processed sequentially and at the same speed as books of identical thicknesses by apparatus in accordance with the present invention.

After cutting, the clamps 14 are released and the transport mechanism 10 indexes the book to the transfer station 5 (FIG. 2).

As shown, the fore-edge cutting action is powered by a drive motor 16c operating rotating cranks 16d. In alternative embodiments electric solenoid action or other drive systems may be used to bring the knives together and so to trim the book to the correct width.

In a further alternative embodiment (not shown) fore-edge trimming may be effected by rotary knives replacing the reciprocating knife assembly. In this case, the book can in principle be pushed past a rotating blade and accordingly, the transport process could be either continuous or indexed.

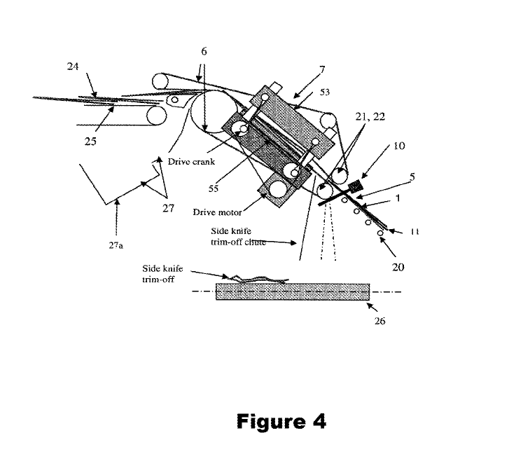

FIG. 4 illustrates in more detail the transfer station 5 along with apparatus for carrying out subsequent process steps. The book 1 arrives from the fore-edge trimming station through action of the transport mechanism 10. During transport the book, still supported on the blade, travels along guides e.g. guide rails, 20, which are arranged to rotate the book about its spine and away from its previous vertical orientation. In the embodiment shown the rotation is 45°. The book 1 thus enters the transfer station 5 travelling along an inclined plane. At the transfer station 5 a stop (not shown) engages with the leading edge of the book 1. This stops the book accurately in an alignment that sets the subsequent trim-off dimension.

One or more pairs of wheels 21, 22 are then brought together to grip the halted book 1 in the vicinity of its spine. Transport belts 6 extend from the wheels 21, 22, through the side-edge and centre-cutting station 7 to the final delivery conveyor 25. These belts 6 are set to pick up the book 1 once it is gripped by the wheels 21, 22. The belts 6 are driven to remove the book from the blade and to carry it across a supporting bed plate 55 to the side-edge and centre-cutting station 7 where it is stopped and clamped. The book is then trimmed and, optionally, cut. Trim-off waste falls downwards and is collected by a waste removal belt 26. The belts 6 then remove the book from the side-edge and centre-cutting station 7. Various prior art devices (not shown) are used throughout the collating, binding and trimming processes to verify that each book contains the correct pages in the correct sequence and that trimming has been properly and accurately effected. On exiting the station 7, faulty books are fed to a reject system 27, including a reject collection tray 27a. Those passing the series of checks form a finished product 24, which is output to the delivery conveyor 25.

In an alternative embodiment (not shown) the gripping wheels 21, 22 are replaced by a pair of push-up fingers. These fingers are arranged to raise the spine of the stack as it reaches the transport belts and to urge the stack onto the belts in this orientation.

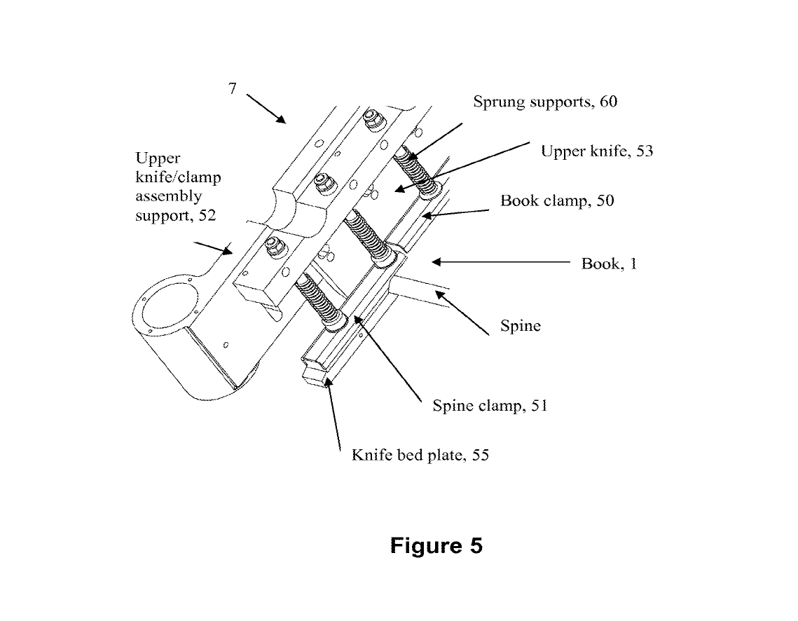

Components of the side-edge and centre-cutting station 7 for clamping and trimming and/or cutting the books in accordance with the present invention are shown in more detail in FIGS. 5-9. In what follows, the assemblies described are replicated at the two side-edges of the book and, if the book is to be cut into several smaller books at this stage, also at one or more parallel centre-knife stations.

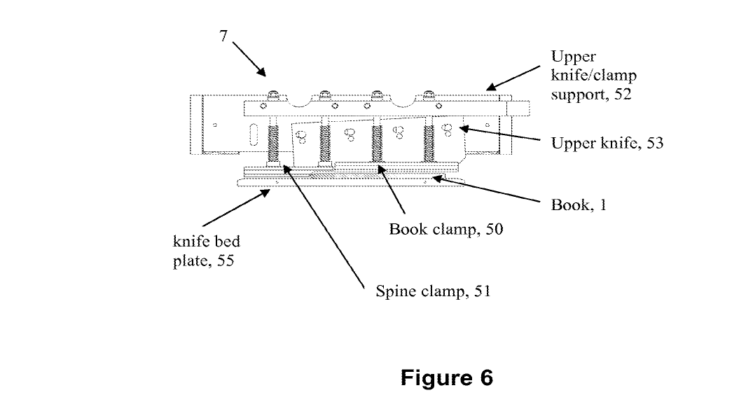

With reference to FIGS. 5 and 6, components of the knife assembly for side and centre trimming are shown in perspective and elevation respectively. Two separate clamps: a book clamp 50 and a spine clamp 51 are mounted via sprung supports 60 on a knife support assembly 52. An upper knife 53 is moveably attached to the support assembly 52. A book that has been stopped within the side-edge and centre-cutting station 7 is also illustrated. The transport system brings the book to rest at a position defined by its spine. That is, the book, on moving upwards spine-first through the apparatus 7, encounters registration stops that engage its spine.

The knife support assembly 52 is then moved perpendicularly towards the book. The spine clamp 51 acts first on the book, pressing the spine 1a onto the knife bed plate 55. The main book clamp 50 only comes into contact with the book once the sheets in the area adjacent to the spine have been clamped as closely as possible to the bed plate 55. Once the book edge is clamped the support assembly 52 continues its travel perpendicular to the book and cutting occurs. Cutting is effected by shear force between the upper knife 53 and the bed plate 55. The sprung supports 60 determine the strength of the force acting on the book at and during the cutting action.

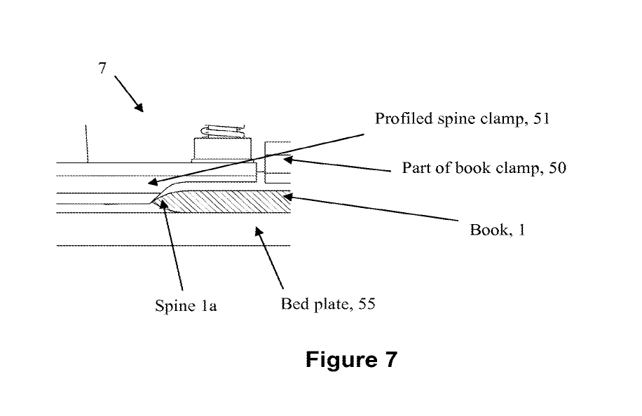

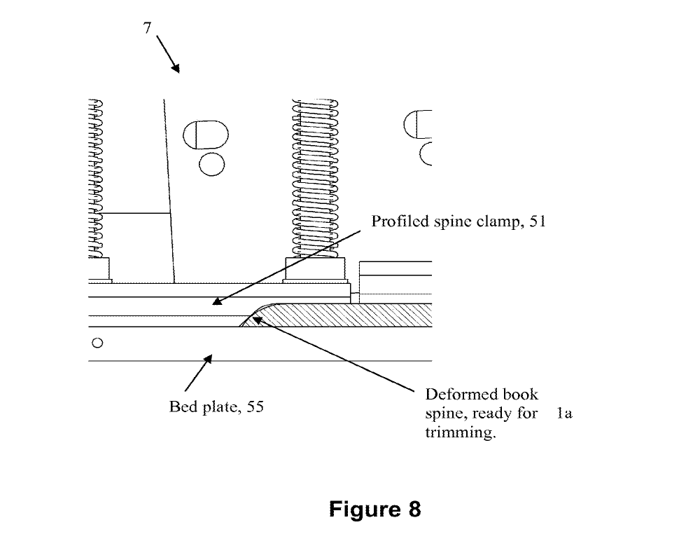

FIGS. 7-9 illustrate a particular design of spine clamp and knife that is preferred for use with this invention. With reference to FIG. 7 the book set 1 is shown lying on the bed plate 55 prior to clamping. As can be seen from the Figure, saddle-type book collation and binding processes generally result in a spine profile that, when the book is at rest, is elevated away from the bed plate 55: its outermost edge will be raised by half a book thickness. The spine clamp 51 has a profile shaped so as to deform the spine as it clamps the book. In the embodiment shown, the clamping surface is arcuate. The outermost edge of the spine is engaged at or near the lowest part of the clamping surface of the spine clamp 51. As the clamp 51 is lowered the spine is deformed and its apex is displaced towards the bed plate 55. The arcuate region of the spine clamp increasingly engages thicker portions of the spine, imparting a general deformation such that the folded sheets of the book are pressed as closely as possible to the knife bed plate 55. The clamped book 1, deformed in the region of its spine 1a, is shown in FIG. 8. As can be seen in this Figure the lower surface of the book, including the spine portion, is pressed flat against the bed plate 55. The book is now held optimally in terms of providing positive reaction to the cutting forces about to be applied.

As will be clear from the foregoing, the spine clamp 51 is shaped with a profile that is suitable to effect the desired deformation. That a range of profiles may be used to achieve this result will readily be apparent to one skilled in the art. The profile must reflect to some extent the thickness of the book being processed. Ideally, however, for maximum flexibility, a profile is selected that works effectively over the full range of anticipated book thicknesses (typically 0.1 mm to 10 mm).

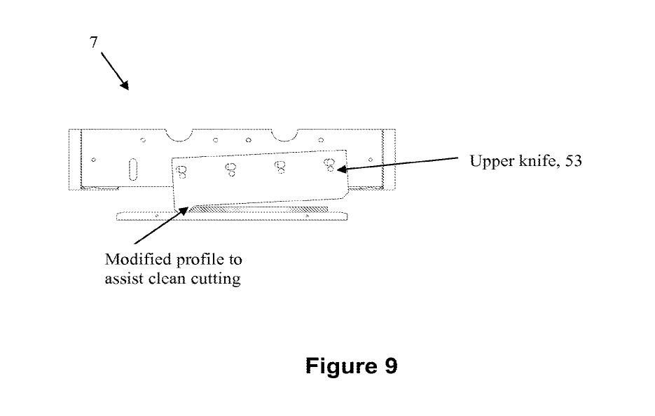

In conventional trimmers the upper knife 53 has a straight edge. In the current embodiment the upper knife is profiled as shown in FIG. 9 (clamps have been removed from this Figure for clarity). That is, it too has a shaped profile, similar to that of the spine clamp 51. This profile ensures that, as the knife 53 starts to cut the book, it co-operates with the spine clamp 51. The sheets of the book are further pressed closely together and against the bed plate 55 by the knife 52. The result is that the side-edge (or centre) is, as far as possible, directly supported as the trim is effected. This helps produce a clean cut adjacent to, and in the first few millimetres away from, the spine.

In an alternative, although not preferred, embodiment (not shown) side-edge and centre trimming may be effected by rotary knives. The transport process could be either continuous or indexed.

1-38. (canceled)

39. A method of trimming a stack of collated sheets folded at a spine along at least one edge perpendicular to the spine, the method comprising the steps of:
(a) providing a spine clamp with profiled spine-engaging surface above the stack in the vicinity of the edge to be trimmed;
(b) moving the clamp towards the stack wherein the profile of the clamp is such that the spine of the stack is engaged first at its apex, which is displaced towards a knife bed plate;
(c) continuing depressing the clamp such that the stack is engaged progressively as it thickens, thereby deforming the spine, until the deformed spine is compressed onto the bed plate; and
(d) trimming the edge of the clamped stack.

40. A method according to claim 39, the method including providing two spine clamps for clamping opposite side-edges of the stack, and trimming both side-edges.

41. A method according to claim 40, the method including providing at least one additional spine clamp for clamping the stack along at least one inner line in a direction perpendicular to the spine and cutting the stack in the vicinity of this inner line.

42. A method according to claim 39 wherein the clamp is mounted on a knife support assembly by means of sprung supports.

43. A method according to claim 39 wherein, after the spine clamp is depressed so as to compress the spine on to the bed plate and prior to trimming, the method includes the additional step of moving a book clamp towards and into engagement with the stack, at a position away from the spine, thereby pressing the bulk of the stack onto the bed plate.

44. A method according to claim 43 wherein the book clamp is mounted on a knife assembly by means of sprung supports.

45. A method according to claim 39 wherein the spine clamp has a rigid arcuate surface.

46. A method according to claim 39 wherein the step of trimming the edge includes moving a knife towards the knife bed plate to cut the stack.

47. A method according to claim 46 wherein the knife has a profiled cutting edge.

48. A method according to claim 47 wherein the knife and stack are positioned such that by moving the knife towards the bed plate, the knife cuts the spine first at its apex and then progressively across the stack as it thickens.

49. A method according to claim 39 wherein the method is preceded by the step of collating the stack on a saddle and, optionally, binding.

50. A method according to claim 39 wherein the method is preceded by the steps of trimming the stack along an edge opposite to the spine such that said opposite edge is oriented substantially parallel to the transport direction just prior to trimming; changing the relative orientation of the stack and transport direction such that the edges perpendicular to the spine are parallel to the transport direction.

51. A method of trimming a stack of collated sheets folded at a spine, the method comprising the steps of:
(a) locating the stack on a knife bed plate;
(b) deforming the spine of the stack, by displacing its apex first towards the knife bed plate and then progressively displacing thicker portions of the spine;
(c) holding the deformed spine such that its surface is substantially flat against the bed plate; and
(d) cutting the stack along an edge perpendicular to the spine whilst supporting said deformed spine on the bed plate.

52. A method according to claim 51 wherein, prior to step (d) and after step (c) above, the method includes the additional step of moving a book clamp towards and into engagement with the stack, at a position remote from the spine, thereby pressing the bulk of the stack onto the bed plate.

53. A method according to claim 51 wherein the method is preceded by the step of collating the stack on a saddle and, optionally, binding.

54. A method according to claim 39 wherein the method is preceded by the steps of trimming the stack along an edge opposite to the spine such that said opposite edge is oriented substantially parallel to the transport direction just prior to trimming; changing the relative orientation of the stack and transport direction such that the edges of the stack that are perpendicular to the spine are parallel to the transport direction.

55. A method according to claim 54 wherein the step of changing the relative orientation of the stack and transport direction includes the step of rotating the transport direction through around 90°.
